(19) United States
(12) Patent Application Publication
(10) Pub. No.: US 2017/0001774 A1
(43) Pub. Date: Jan. 5, 2017

(54) Lighted Gift Box

(71) Applicant: Kathleen M. West, Longs, SC (US)

(72) Inventor: Kathleen M. West, Longs, SC (US)

(21) Appl. No.: 14/790,003

(22) Filed: Jul. 2, 2015

(51) Int. Cl. B65D 51/24; F21V 33/00

(52) U.S. Cl. CPC B65D 51/245; F21V 33/0004; F21Y 2101/02; F21Y 2105/003

(57) ABSTRACT

A gift presentation and gift delivery system is disclosed. It is a gift box with illuminated decorative patterns on the box. The gift box is illuminated with battery-operated LED lights in various colors and patterns to give an aesthetic look to the gift box. This is used in combination with customized 2D and/or 3D artwork for a particular occasion and/or event.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

(1) Field of Invention

The present invention relates, in general, to the field of gift presentation and gift delivery using gift boxes. Specifically, this invention relates to lighted gift boxes that are also customizable art work.

(2) Background of Invention

Gift presentation has generally been limited to the gift box or gift bag markets. These gift presentation methods tend to be single-use systems that have separate wrapping paper, bows, tape and other accessories that the gift giver needs to combine or hire someone to combine. These prior art methods create a great amount of paper and cardboard trash that goes into the waste systems of communities, and offers the user a limited set of presentation options. These methods of gift presentation also require a certain level of experience to decorate adequately to maximize the beauty of the gift presentation. They also tend to be tedious to use in the case of wrapping paper systems, as it takes a signification amount of time to wrap each individual gift.

Gift bags, on the other hand, are easier to utilize, but have gift capacity and concealment issues. Gift bags, generally, are not sealed. Unless the gift giver makes an effort to cover the gift with tissue or other filler, tape, or otherwise seal the gift bag, the open top of the gift bag can reveal the gift within before the gift giver wants the recipient to see the gift. The gift bags also have another problem. To conceal the gift in the gift bag, the gift bag cannot be filled to the top by the gift. In other words, the whole space for the gift cannot be utilized to hold the gift, as the bag also must be big enough to seal or to place a covering, such as tissue paper, to conceal the gift.

Gift boxing and wrapping are necessary components of gift giving. Often, gift givers need dedicated space for wrapping paper of all varieties and boxes of various sizes and shapes to accommodate such gifts. Gift bags are one accommodation to the space requirements of traditional gift boxes and wrapping. However, like wrapping paper, gift bags are generally thematic, and not all gift bags are appropriate for all gift giving situations.

As such, a need arises for a customizable gift box that is appropriate for a gift for a particular event, occasion, season, and/or recipient. Such customizable gift boxes eliminate the need for a gift giver to stock and/or independently purchase tailor-made gift wraps and bags for each particular event, occasion, season, and/or recipient.

The present invention seeks to provide an illuminated gift box that is customizable with various art works that attempts to overcome the shortfalls of the present gifting system.

This permits the use of the present invention, which enhances the prior art of gift presentation and gift delivery using gift boxes.

### BRIEF SUMMARY OF THE INVENTION

In view of the foregoing disadvantages inherent in the known types of the gifting system now present in the prior art, the present invention provides a gift presentation and gift delivery system and method wherein the same uses and provides a gift box, with the illuminated decorative pattern on the top and use on the process of various components employed in the procedure. As such, the general purpose of the present invention, which will be described subsequently in greater detail, is to provide a new and improved method and system for gift presentation and gift delivery using gift boxes that have all of the advantages of the prior art, and none of the disadvantages.

Accordingly, it is a primary objective of the present invention to provide an illuminated gift box.

In a further aspect, the present invention gift box is illuminated with battery-operated LED lights.

In another aspect, the LED lights vary in colors and patterns to give an aesthetic look to the gift box.

It is yet another objective of the present invention to provide gift boxes that are customizable with 2D and/or 3D artwork for a particular occasion and/or event.

A further aspect of the present invention allows various themes for gift boxes, such as Christmas, Birthday, Valentine's Day, and the likes.

It is another objective of the present invention to provide a gift box with the decorative pattern on the top of the box.

It is still another objective of the present invention to provide a new and improved lighted gift box that may be easily and efficiently manufactured and marketed.

It is a further objective of the present invention to provide a new and improved lighted gift box that is of a durable and reliable construction.

Other aspects of the present invention will become apparent, from time to time, throughout the specification, as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting.

These, together with other aspects of the invention and the various features of novelty that characterize the invention, are pointed out with particularity in the disclosure. For a better understanding of the invention, its operating advantagesm and the specific objectives attained by its uses, reference should be had to the accompanying drawings and descriptive matter in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and id, therefore, not to be considered limiting of its scope. The invention will be described and explained with additional specificity and detail through the use of the accompanying drawing, in which:

FIG. 1 is a front view of the gift boxes.

FIG. 2 is a top view of the gift box with a Christmas theme.

FIG. 3 is a top view of the gift box.

### DETAILED DESCRIPTION OF THE INVENTION

Various aspects of the illustrative embodiments will be described using the terms commonly employed by those skilled in the art to convey the substance of their work to others skilled in the art. However, it will be apparent to those skilled in the art that the present invention may be practiced with only some of the described aspects. For purposes of explanation, specific numbers, materials, and configurations are set forth in order to provide a thorough understanding of the illustrative embodiments. However, it will be apparent to one skilled in the art that the present invention may be practiced without the specific details. In other instances, well-known features are omitted or simplified in order to not obscure the illustrative embodiments.

In some preferred embodiment, a new approach is proposed that presents a system for gift presentation and gift delivery using gift boxes. Herein, a gift box is disclosed with a decorative pattern on the top surface of the gift box. The pattern includes light emitting diode (LED) lights that are operated with a battery. The LED lights may constitute the pattern, or they may contribute to or enhance a pattern supported by other visual elements.

In another embodiment, these gift boxes come in a wide variety of forms, shapes, sizes, and colors. As a whole, the gift boxes may vary broadly in the composition of the substrate of which they are made, their weight, structure, and transportability, but they all have in common the property that they are articles designed to hold other articles, specifically the gift item. Such box embodiments may be designed and manufactured in many sizes to hold a range of articles, including, for example, candy, food items, or any manner of gifts, including apparel to houseware items.

These particular gift boxes embodiments are closely associated with gift giving. They are inventively enhanced through an integrated light emitting diode (LED) technology that creates or contributes to a pattern on the surface of the gift box. Other embodiments of the invention are more particularly adapted to holding or carrying articles that have a perceived value, or are noteworthy or special in some way, but do not necessarily constitute a gift.

Further, the gift boxes are customizable with 2D and/or 3D artwork for the various themes for a particular occasion and/or event, to give an aesthetic look to a gift box. The patterns included on the gift boxes of the present invention are typically decorative in design, and are customized for different occasions, including Christmas, Birthday, St. Patrick's Day, Easter Day, Valentine's Day, and other similar occasions/events.

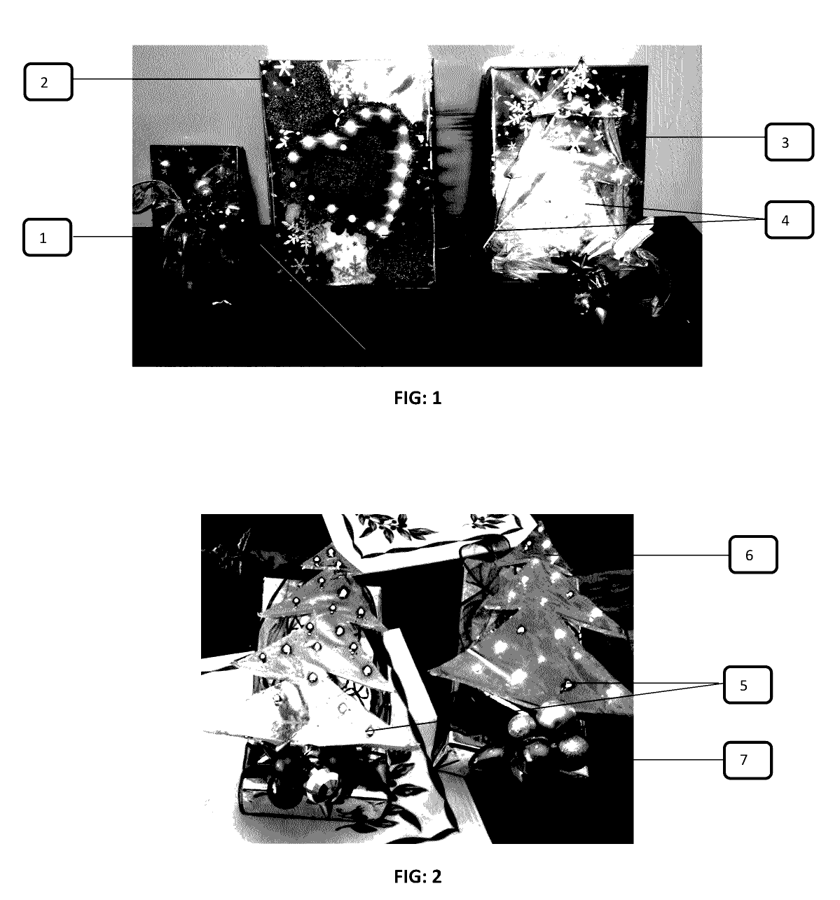

With reference now to the drawings, and in particular to FIG. 1 to FIG. 3 thereof, a new and improved gift box embodying the principles and concepts of the gift presentation and gift delivery system is described herein.

To address the various needs of the disclosed embodiments, the present invention is a system for gift presentation comprising a gift box that is capable of containing a gift. The box has at least four interconnected side panels and a bottom panel, including at least two generally opposed main panels and at least two generally opposed side panels. The main panels and side panels each terminate at the bottom panel, and each pair of the opposed main panels and the side panels terminate in a common plane for each of the pair of main panels and each of the pair of the side panels at an open end of the gift box. This creates a structure for successfully retaining a gift item, including a cover that is operably connected to the open end of the gift box. The cover may be a detachable component separated from the box, and includes a functional decorative material operably mounted on the gift box.

The functional decorative material is defined as any material that may be added to the cover or the gift box that allows a decorative or structural component of the gift presentation system to enhance the gift giving experience of either the giver or recipient of the gift. These decorative materials include LED lights, Christmas trees, decorative balls, heart shaped elements, and other glossy materials.

In FIG. 1, an embodiment of the lighted gift box is illustrated, which is to give a gift in a box that almost a gift in itself. This box is designated, generally, by the reference characters 1, 2, and 3, as shown in their front view herein. The gift box involves 3D artwork that is customized with the various themes for the occasion of Easter day 1, Valentine's Day 2 and Christmas Day 3, respectively, with the different pattern of the colorful LED lights 4 designed for a particular gift box.

Further, FIG. 2 shows the top view of the gift box customized with the Christmas Day event. Along with the LED lights 5, the art work involves other decorative materials 6 and 7 that complement the theme of the occasion to gift.

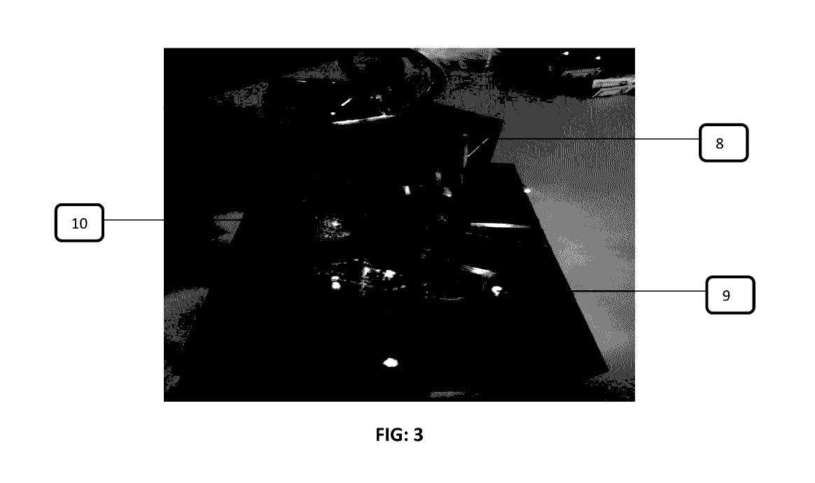

In accordance with the invention, the gift box 8 in its top view in FIG. 3 also illustrates the other theme customized for a particular event/occasion, with a decorative pattern of LED lights 9 and other decorative materials 10.

Embodiments of the invention may include gift boxes that are designed for any cultural or religious holiday, for commercial purposes, for individualized/customized boxes, or for one-time occasions. The audience to whom such containers appeal includes people of any age, and of any cultural, ethnic, or religious tradition. In addition to serving as a gift box for articles, embodiments of the invention, themselves, are articles valued for their design or beauty, and, as such, may be displayed as articles of intrinsic interest or kept as memorabilia.

It is to be understood that the above description is intended to be illustrative, and not restrictive. For example, the above-discussed embodiments may be used in combination with each other. Many other embodiments will be apparent to those of skill in the art upon review of the above description.

The benefits and advantages that may be provided by the present invention have been described above with regard to specific embodiments. These benefits and advantages, and any elements or limitations that may cause them to occur or to become more pronounced, are not to be construed as critical, required, or essential features of any or all of the embodiments.

While the present invention has been described with reference to particular embodiments, it should be understood that the embodiments are illustrative, and that the scope of the invention is not limited to these embodiments. Many variations, modifications, additions, and improvements to the embodiments described above are possible. It is contemplated that these variations, modifications, additions, and improvements fall within the scope of the invention.

I claim:

1. A system for gift presentation and gift delivery, comprising:
a. a box for containing a gift;
b. a cover for the box; and
c. a decorative material operably mounted on the box.

2. A system of claim 1, wherein said box is a lighted gift box.

3. A system of claim 1, wherein said box comprising:
a. at least four interconnected side panels;
b. a bottom panel;
c. at least two generally opposed main panels;
d. at least two generally opposed side panels.

4. A system of claim 3, wherein said main panels and said side panels each terminate at the bottom panel, and each pair of the opposed main panels and the side panels terminate in a common plane for each of the pair of main panels and each of the pair of the side panels at an open end of the box

5. A gift box of claim 1, wherein said decorative material includes LED lights.

6. A gift box of claim 1, wherein said decorative material includes LED lights are operated with a battery.

7. A gift box of claim 1, wherein said box involves customized 2D artwork with various themes for different occasions.

8. A gift box of claim 1, wherein said box involves customized 3D artwork with various themes for different occasions.

9. A gift box of claim 1, wherein said gift box is used on various occasions, including Christmas, Birthday, St. Patrick's Day, Easter Day, Valentine's Day, and other similar occasions/events.
